(19) United States
(12) Patent Application Publication
(10) Pub. No.: US 2018/0121082 A1
(43) Pub. Date: May 3, 2018

(54) METHOD AND APPARATUS FOR SPLIT SCREEN DISPLAY

(71) Applicant: Beijing Xiaomi Mobile Software Co., Ltd., Beijing (CN)

(72) Inventors: Yin ZHU, Beijing (CN); Jiong LI, Beijing (CN); Zhenzhou LU, Beijing (CN)

(21) Appl. No.: 15/790,603

(22) Filed: Oct. 23, 2017

(30) Foreign Application Priority Data
Oct. 31, 2016 (CN) PCT/CN2016/103961

(51) Int. Cl. G06F 3/0488; G06F 3/0484

(52) U.S. Cl. CPC G06F 3/04886; G06F 3/041; G06F 3/04847

(57) ABSTRACT

A method for split screen display on an electronic device, includes: receiving an operation signal which triggers displaying a multi-task management interface; displaying the multi-task management interface, wherein the multi-task management interface displays thereon acquired applications running on the electronic device; when it is detected that a user selects a first application and at least one second application from the acquired applications, generating a split screen display interface based on the first application and the at least one second application; and displaying the split screen display interface, so that the first application and the at least one second application are running and displayed on the split screen display interface simultaneously.

### CROSS-REFERENCE TO RELATED APPLICATION

This application is based on and claims priority to International Application No. PCT/CN2016/103961, filed Oct. 31, 2016, the entire contents of which are incorporated herein by reference.

### TECHNICAL FIELD

The present disclosure is generally related to the technical field of electronic devices, and more particularly, to a method and apparatus for split screen display.

### BACKGROUND

An electronic device installed with a smart operating system allows only one application to run in a foreground of the electronic device. That is, only one application in a running state can be displayed on a display screen of the electronic device.

When a user needs to use two applications at the same time, the user has to repeatedly switch the application running in the foreground. For example, the user needs to use application A and application B at the same time. The application A is running in the foreground and the application B is running in the background. When the user needs to view the application B, the user has to first switch the application A to running in the background and then switch the application B to running in the foreground. When the user needs to view the application A again, the user has to switch the application A to running in the foreground again. Such a manner for displaying applications on an electronic device according to the related prior art is inconvenient to a user.

### SUMMARY

According to a first aspect of the disclosure, there is provided a method for split screen display on an electronic device, comprising: receiving an operation signal which triggers displaying a multi-task management interface; displaying the multi-task management interface, wherein the multi-task management interface displays thereon acquired applications running on the electronic device; when it is detected that a user selects a first application and at least one second application from the acquired applications, generating a split screen display interface based on the first application and the at least one second application; and displaying the split screen display interface, so that the first application and the at least one second application are running and displayed on the split screen display interface simultaneously.

According to a second aspect of the disclosure, there is provided an apparatus for split screen display, comprising: a processor, and a memory storing instructions executable by the processor. The processor is configured to: receive an operation signal which triggers displaying a multi-task management interface; display the multi-task management interface, wherein the multi-task management interface displays thereon acquired applications running on the apparatus; when it is detected that a user selects a first application and at least one second application from the acquired applications, generate a split screen display interface based on the first application and the at least one second application; and display the split screen display interface, so that the first application and the at least one second application are running and displayed on the split screen display interface simultaneously.

According to a third aspect of the disclosure, there is provided a non-transitory computer-readable storage medium having stored therein instructions that, when executed by a processor of an apparatus, causes the apparatus to perform a split screen display method, the method comprising: receiving an operation signal which triggers displaying a multi-task management interface; displaying the multi-task management interface, wherein the multi-task management interface displays thereon acquired applications running on the apparatus; when it is detected that a user selects a first application and at least one second application from the acquired applications, generating a split screen display interface based on the first application and the at least one second application; and displaying the split screen display interface, so that the first application and the at least one second application are running and displayed on the split screen display interface simultaneously.

It should be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 is a flowchart of a split screen display method according to an exemplary embodiment.

FIG. 2A is a flowchart of a split screen display method according to another exemplary embodiment.

FIG. 2B is a schematic diagram illustrating triggering of display of a multi-task management interface according to an exemplary embodiment.

FIG. 2C is a schematic diagram of a multi-task management interface according to an exemplary embodiment.

FIG. 2D is a schematic diagram illustrating a process of generating a preview of a split screen display interface according to an exemplary embodiment.

FIG. 2E is a schematic diagram illustrating a process of generating a preview of a split screen display interface according to an exemplary embodiment.

FIG. 2F is a schematic diagram illustrating a split screen display interface according to an exemplary embodiment.

FIG. 2G is a schematic diagram illustrating a split screen display interface according to an exemplary embodiment.

FIG. 2H is a schematic diagram illustrating a state switched to when a virtual button on a split screen display interface is triggered according to an exemplary embodiment.

FIG. 2I is a schematic diagram illustrating a process of generating a preview of a split screen display interface according to an exemplary embodiment.

FIG. 2J is a schematic diagram illustrating a split screen display interface according to an exemplary embodiment.

FIG. 2K is a schematic diagram illustrating a split screen display interface according to an exemplary embodiment.

FIG. 3 is a block diagram of a split screen display apparatus according to an exemplary embodiment.

FIG. 4 is a block diagram of a split screen display apparatus according to another exemplary embodiment.

FIG. 5 is a block diagram of a split screen display apparatus according to an exemplary embodiment.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise indicated. The implementations set forth in the following description of embodiments do not represent all implementations consistent with the disclosure. Instead, they are merely examples of apparatuses and methods consistent with aspects related to the disclosure as recited in the appended claims.

It can be appreciated that, while the terms “first”, “second”, “third” and so on may be used herein to describe various information, such information is not limited to these terms, which are only used to distinguish between different information of the same category. For example, the first information can also be referred to as the second information, and similarly the second information can also be referred to as the first information, without departing from the scope of the present disclosure. Depending on the context, the term “if” as used herein can be interpreted as “when”, “while”, or “in response to determining”.

Technical solutions according to embodiments of the disclosure are applicable to an electronic device. The electronic device may be any kind of terminal that can be operated by touching on its touch screen. Such a terminal may be for example a touch screen terminal including a processor and a display output component. Such a terminal may include, but not limited to, a smart phone, a tablet or a personal digital assistant (PDA).

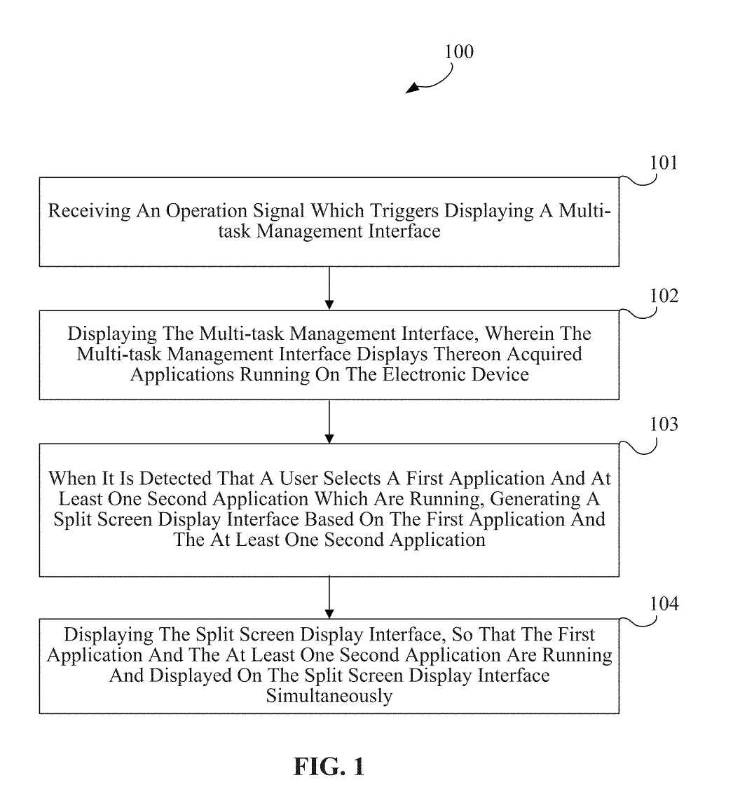

FIG. 1 is a flowchart of a method 100 for split screen display according to an exemplary embodiment. The method 100 may be used in an electronic device having a touch screen, and may include the following steps.

In step 101, an operation signal which triggers displaying a multi-task management interface is received.

In step 102, the multi-task management interface is displayed, wherein the multi-task management interface displays thereon acquired applications running on the electronic device.

In step 103, when it is detected that a user selects a first application and at least one second application which are running, a split screen display interface is generated based on the first application and the at least one second application.

For example, the user may select the first application and/or the second application from the applications which are running on the electronic device and which are displayed on the multi-task management interface. The electronic device generates the split screen display interface based on the first application and the second application selected by the user. In some embodiments, when it is detected that the user selects the first application and the at least one second application which are running, the detection triggers generation, in the multi-task management interface, of a preview interface corresponding to the split screen display interface based on the first application and the at least one second application.

In some embodiments, triggering generation, in the multi-task management interface, of the preview interface corresponding to the split screen display interface based on the first application and the at least one second application may comprise: sequentially stitching the first application and the at least one second application to generate the preview interface corresponding to the split screen display interface, so that the preview interface is divided into a first display area and a second display area according to the stitching sequence of the first application and the at least one second application. The first display area displays the first application and the second display area displays the at least one second application.

In step 104, the split screen display interface is displayed, so that the first application and the at least one second application are running and displayed on the split screen display interface simultaneously.

In some embodiments, displaying the split screen display interface, so that the first application and the at least one second application are running and displayed on the split screen display interface simultaneously, may comprise: controlling the electronic device to run and display the split screen display interface according to a page layout of the preview interface, so that the first application is running and displayed in a first area of the split screen display interface and the at least one second application is running and displayed in a second area of the split screen display interface.

According to the method 100 provided by the exemplary embodiment of the disclosure, an operation signal which triggers displaying of a multi-task management interface is received; the multi-task management interface is displayed; when it is detected that a user selects a first application and at least one second application which are running and which are displayed on the multi-task management interface, a split screen display interface is generated; and then the first application and the at least one second application are running and displayed on the split screen display interface simultaneously. By running and displaying the first application and the second application, which are selected by the user, on the generated split screen display interface simultaneously, the user is enabled to use at least two different applications simultaneously, thereby solving the problem in the related prior art that the manner for displaying applications on an electronic device is inconvenient to the user and achieving the effect of improving user experience.

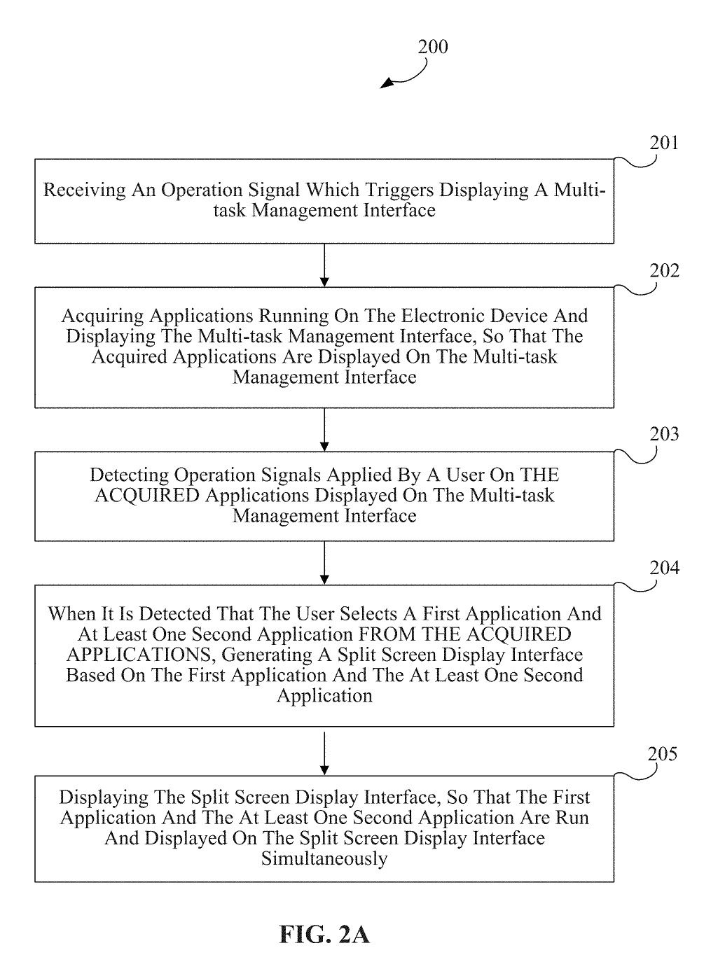

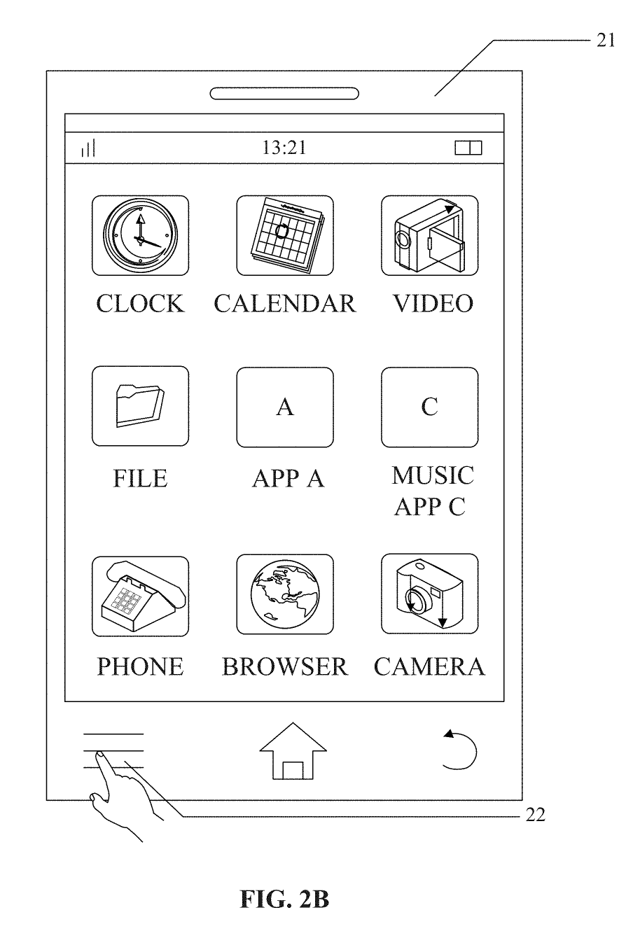

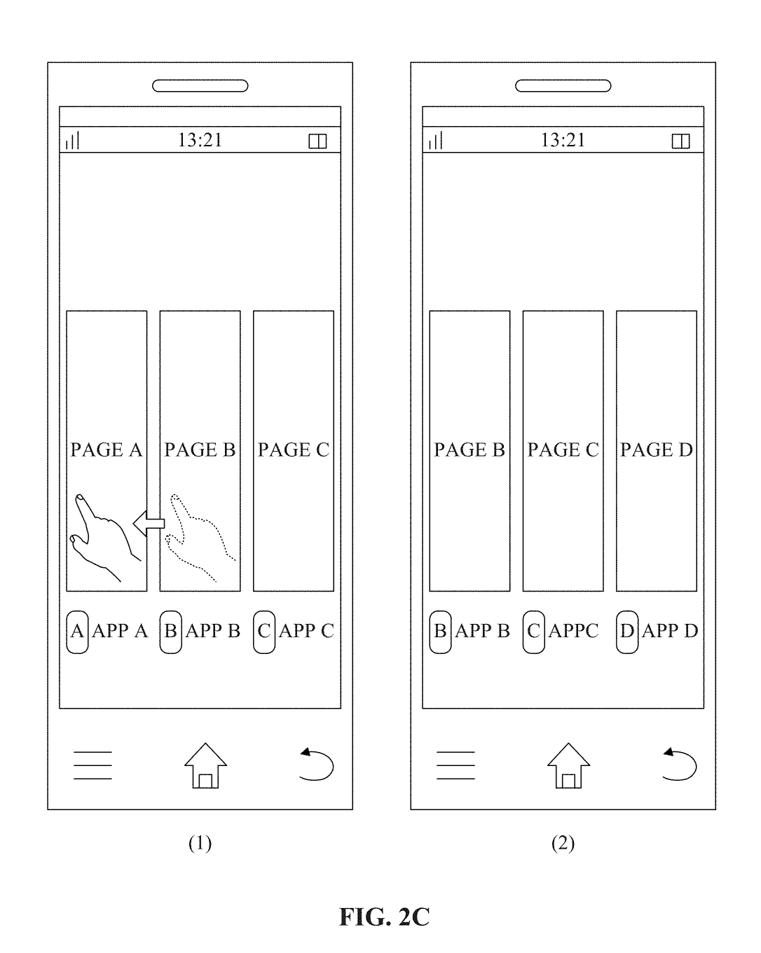

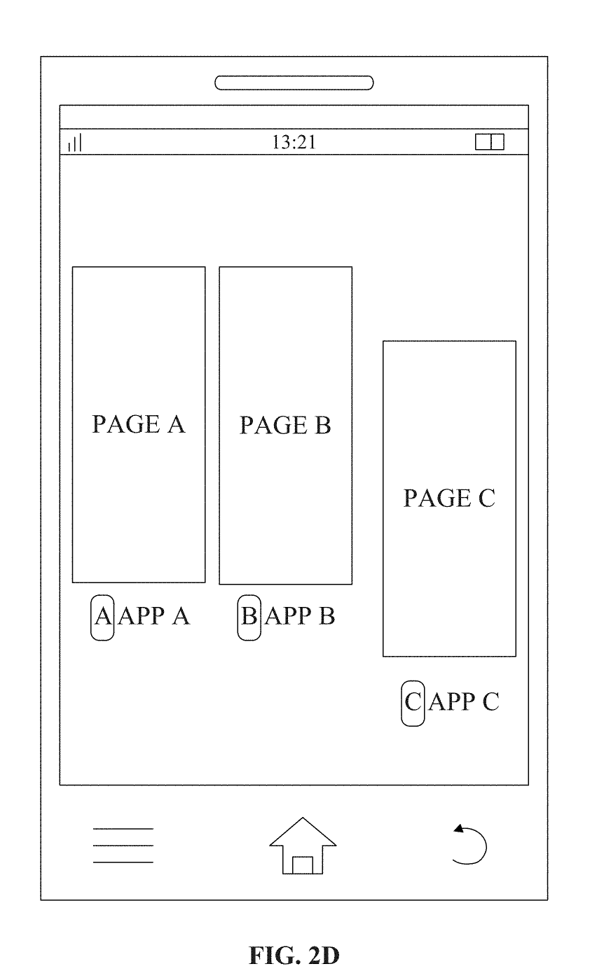

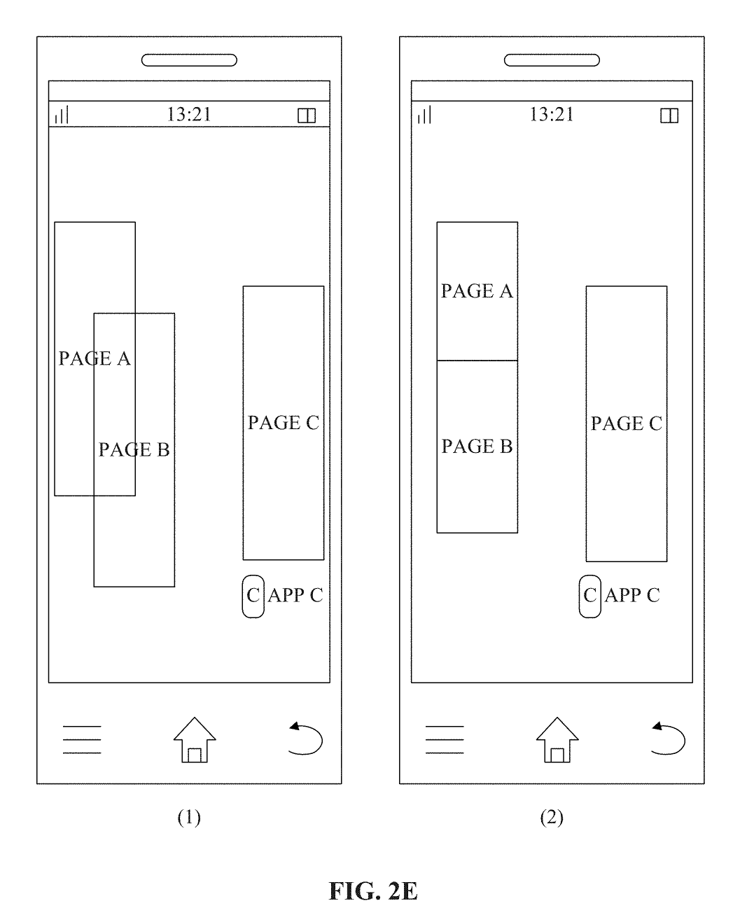

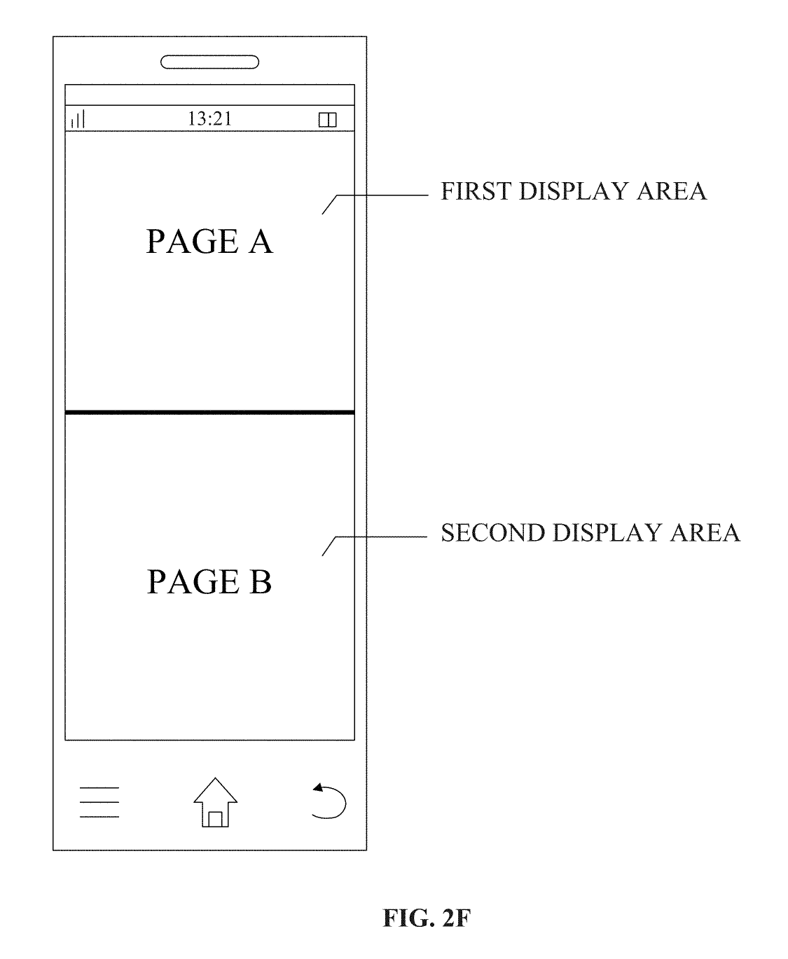

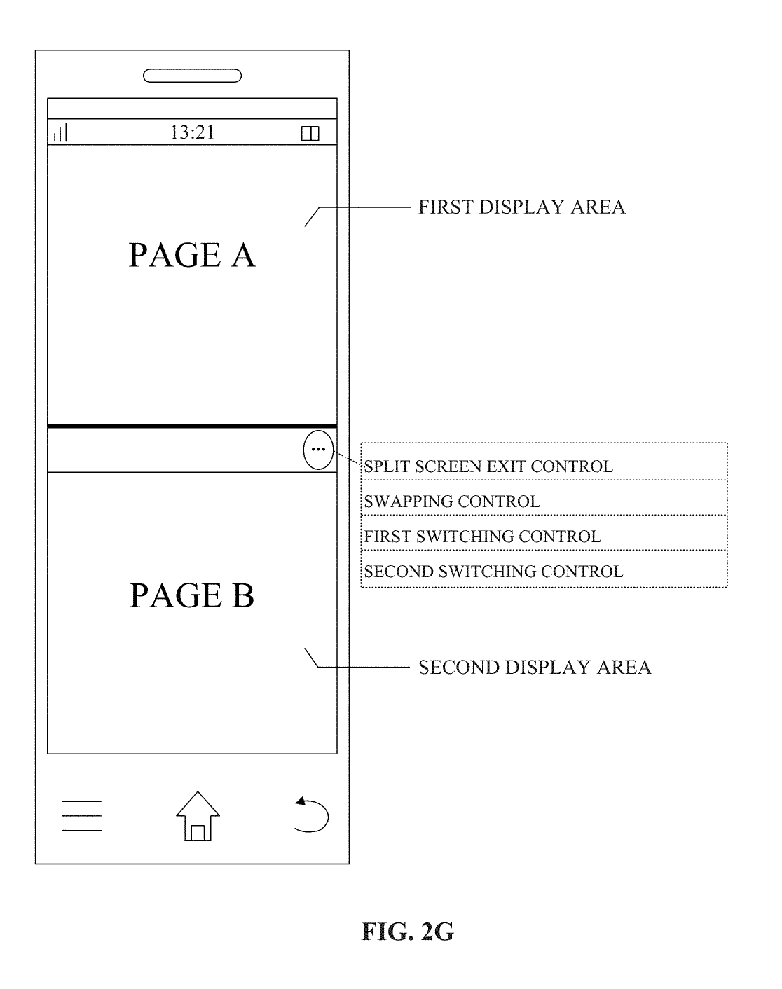

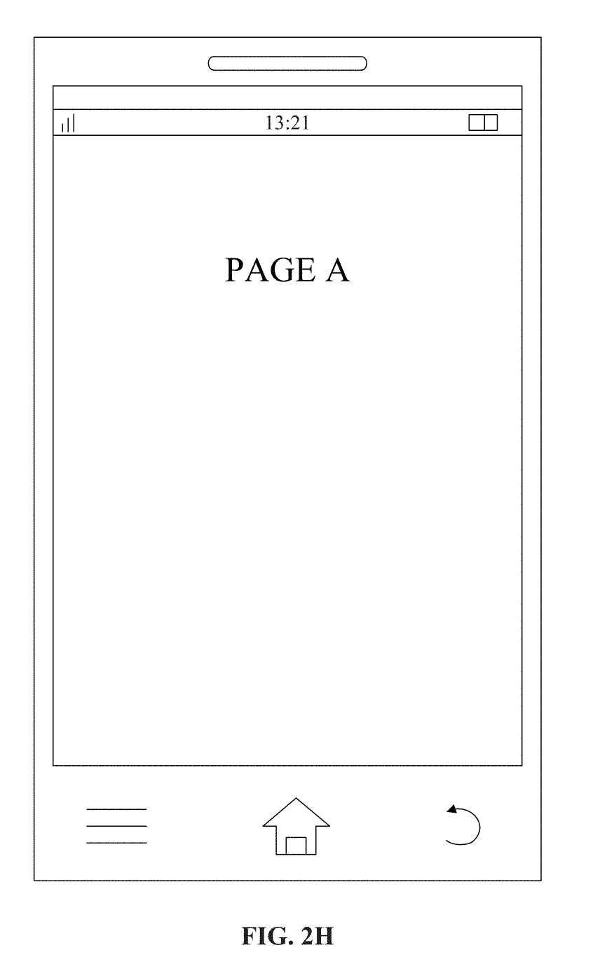

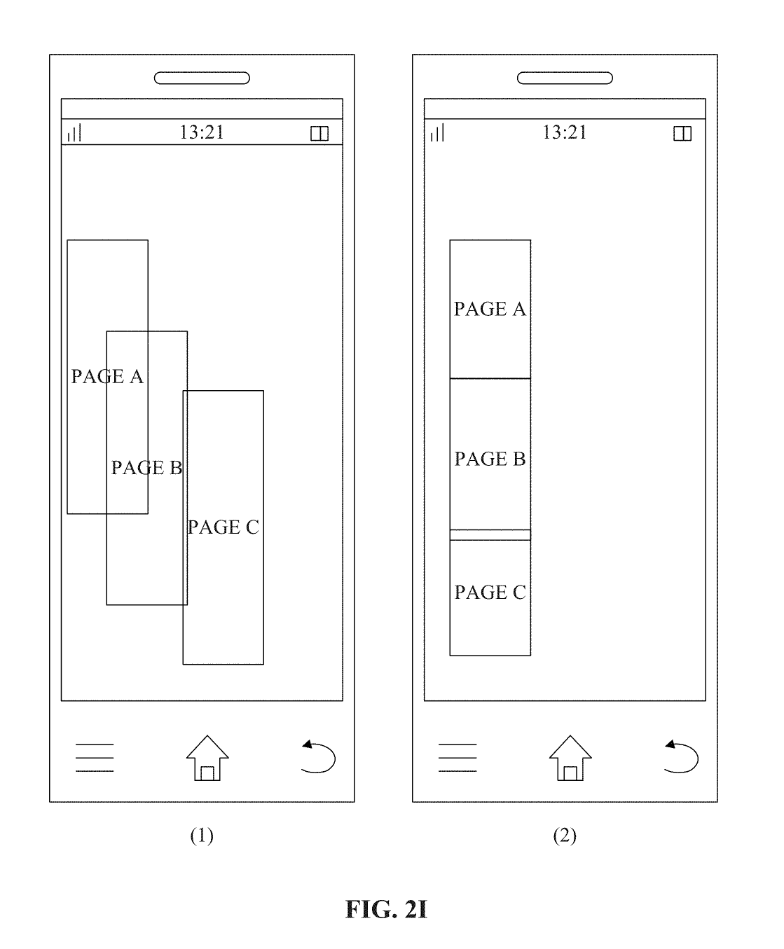

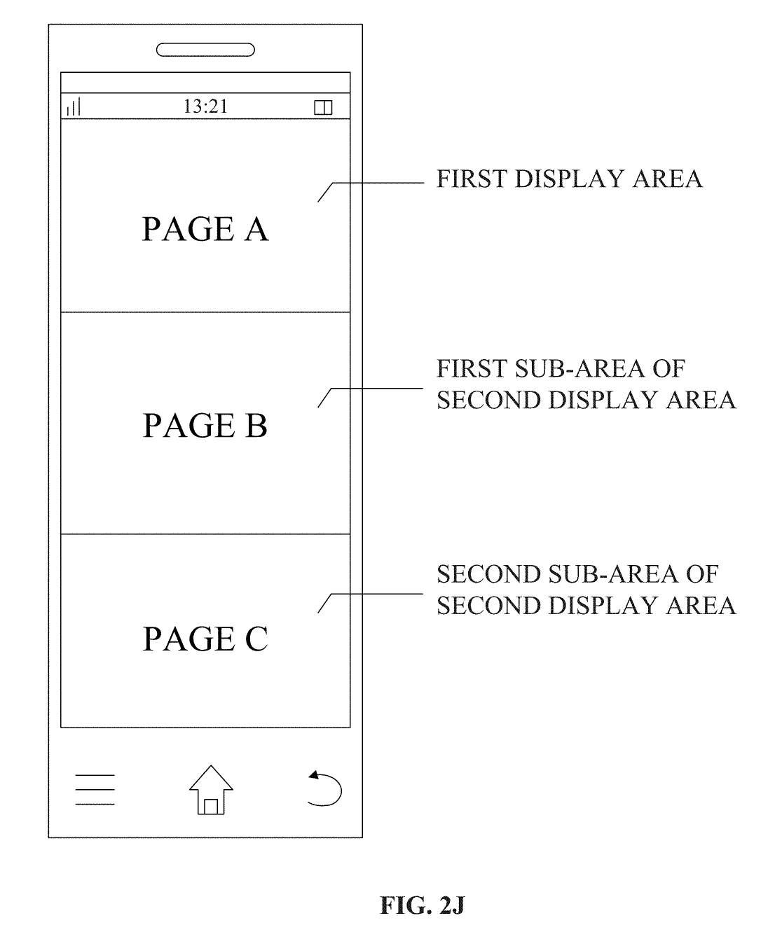

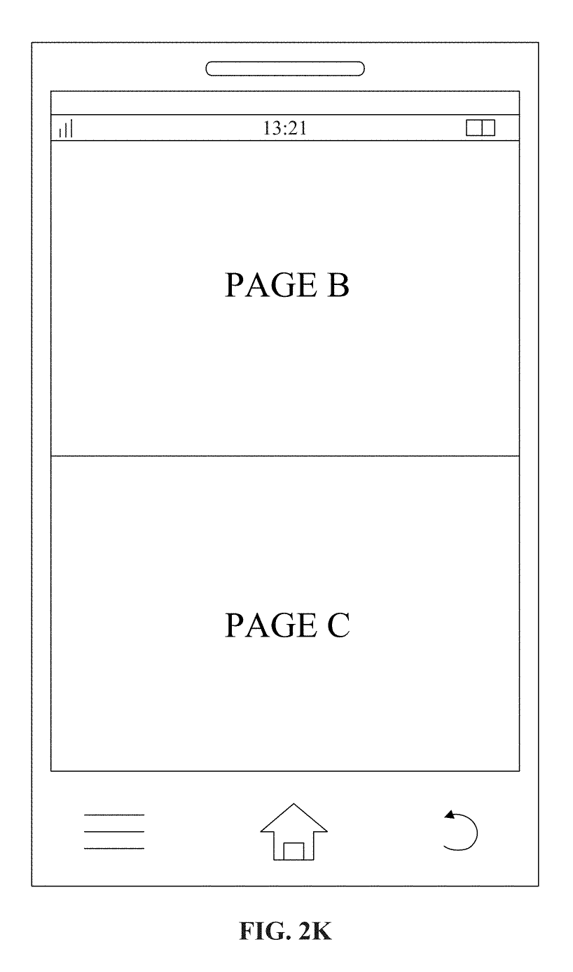

FIG. 2A is a flowchart of a method 200 for split screen display according to another exemplary embodiment. The method 200 may be implemented in an electronic device with a touch screen and may comprise the following steps.

In step 201, an operation signal which triggers displaying a multi-task management interface is received.

For example, the operation signal may be a signal generated when a physical button on the electronic device is triggered, may be a gesture input by a user on the touch screen of the electronic device, or may be a signal generated when the electronic device is moved along a predetermined trajectory while being shaken. The operation signal is not limited in the present disclosure, and can be determined according to actual conditions.

The exemplary embodiment is described by taking an example where the operation signal is generated by triggering a physical button on an electronic device. As shown in FIG. 2B, an electronic device 21 has a multi-task button 22 configured to trigger displaying a multi-task management interface. When a user presses the multi-task button 22, the electronic device receives an operation signal which triggers displaying a multi-task management interface.

The multi-task management interface typically displays applications which are running Each application may be displayed in the form of its preview interface in the multi-task management interface. The preview interface may be a page most recently displayed on a display screen of the electronic device before the application exits foreground running The preview interface of the application may also be a home interface of the application.

In step 202, applications running on the electronic device are acquired, and the multi-task management interface is displayed so that the acquired running applications are displayed on the multi-task management interface. When the acquired running applications are displayed on the multi-task management interface, each application is displayed in the form of its preview interface.

The preview interfaces of the applications may be displayed in various arrangements. For example, the preview interfaces of the applications may be arranged horizontally in a single row according to a first predetermined order for display. As another example, the preview interfaces of the applications may be arranged horizontally arranged in two rows according to the first predetermined order for display. The first predetermined order may be an order in which the applications are opened recently or an order based on frequencies at which the applications are opened. The first predetermined order is not limited in the present disclosure, and can be determined according to actual conditions.

Typically, only a limited number of preview interfaces can be displayed on the display screen of the electronic device. If a user needs to view preview interfaces of more running applications, the user may trigger displaying preview interfaces of more running applications by inputting a predetermined gesture. For example, the running applications include an application A, an application B, an application C and an application D. As shown in FIG. 2C(1), when preview interfaces of the applications are arranged horizontally in a single row for display, the application D cannot be displayed in the display screen due to a limited size of the display screen. Then, the user may trigger displaying a preview interface of the application D by inputting a right-to-left sliding gesture (indicated by an arrow in FIG. 2C(1)), as shown in FIG. 2C(2).

In step 203, operation signals applied by the user on the applications displayed on the multi-task management interface are detected.

The operations signals are generated when the user operates preview interfaces of the applications displayed on the multi-task management interface through touching the display screen. In the exemplary embodiment, by touching the display screen the user may move a displayed preview interface of an application, slide a preview interface of an application to cancel displaying of the application on the multi-task management interface, click a function identification on a preview interface of an application to perform a corresponding operation, switch a displayed preview interface of an application on the multi-task management interface by performing a sliding gesture, and so forth.

In the exemplary embodiment, the touch screen of the electronic device supports multi-touch operations. Thus, the user can simultaneously operate, via multiple fingers, preview interfaces of multiple applications displayed on the multi-task management interface. For example, preview interfaces of multiple applications may be selected simultaneously and moved by performing multi-touch operations. When the user performs touch operations on displayed preview interfaces of applications, the electronic device detects signals of the user's touch operations and analyzes the signals. If the touch operation signals indicate that the user selects preview interfaces of a first application and at least one second application, step 204 is executed.

In step 204, when it is detected that the user selects the first application and the at least one second application which are running, a split screen display interface is generated based on the first application and the at least one second application.

In the exemplary embodiment, generating the split screen display interface based on the first application and the at least one second application may comprise: when it is detected that the user selects the first application and the at least one second application which are running, triggering generation, in the multi-task management interface, of a preview interface corresponding to the split screen display interface based on the first application and the at least one second application.

In the exemplary embodiment, triggering generation, in the multi-task management interface, of the preview interface corresponding to the split screen display interface based on the first application and the at least one second application may comprise: sequentially stitching the first application and the at least one second application to generate the preview interface corresponding to the split screen display interface, so that the preview interface is divided into a first display area and a second display area according to the stitching sequence of the first application and the at least one second application. The first display area displays the first application and the second display area displays the at least one second application.

In the exemplary embodiment, when it is detected that the user selects preview interfaces of the first application and the at least one second application which are running, generation, in the multi-task management interface, the preview interface corresponding to the split screen display interface is triggered to be performed based on the preview interfaces of the first application and the at least one second application. Then, operation signals applied by the user on the preview interfaces of the first application and the second application are detected. If it is detected that the user moves the preview interfaces of the first application and the second application to stitch them together, a stitched-together interface which is a preview of the split screen display interface is generated according to a stitching sequence of these two preview interfaces. Taking the stitching line of the preview interfaces of the first application and the second application as a dividing line, the preview of the split screen display interface is divided into two areas, which are referred to as a first display area and a second display area in the exemplary embodiment. The first display area displays the preview interface of the first application, and the second display area displays the preview interface of the second application.

In the exemplary embodiment, the preview interfaces of the first application and the second application may be stitched together by operating, with two fingers simultaneously, two selected preview interfaces of applications to move them towards each other so that they are stitched together or by operating one of two selected preview interfaces of applications to move it towards the other one so that the two selected preview interfaces of applications are stitched together.

When there is only one second application, there is only one second display area for displaying the only one second application. When there are multiple second applications, there are multiple corresponding second display areas for respectively displaying the multiple second applications. The multiple corresponding second display areas are divided along the stitching lines of preview interfaces of the multiple second applications.

The user may generate, by stitching, the preview of the split screen display interface in the multi-task management interface, so that the user can design the split screen display interface before the electronic device displays the split screen display interface.

In the exemplary embodiment, the user may stitch together the preview interfaces of the first application and the second application in an upper-lower arrangement or in a left-right arrangement.

FIGS. 2D and 2E schematically illustrate a process for generating a preview of a split screen display interface according to an embodiment. As shown in FIG. 2D, a user selects the preview interfaces of the application A and the application B by performing a multi-touch operation on the multi-task management interface. The preview interfaces of the application A and the application B are highlighted. Afterwards, by dragging these two preview interfaces, the user may stitch them together according to a desired order. For example, the preview interfaces of the application A and the application B may be stitched together in an upper-lower arrangement, as shown in FIGS. 2E(1) and 2E(2), to generate the preview of the split screen display interface.

In step 205, the split screen display interface is displayed, so that the first application and the at least one second application are running and displayed on the split screen display interface simultaneously.

In the exemplary embodiment, displaying the split screen display interface, so that the first application and the at least one second application are running and displayed on the split screen display interface simultaneously, may comprise: controlling the electronic device to run and display the split screen display interface according to a page layout of the preview interface, so that the first application is running and displayed in a first area of the split screen display interface and the at least one second application is running and displayed in a second area of the split screen display interface. As such, the user can operate multiple applications simultaneously on the split screen display interface.

FIG. 2F is a schematic diagram of a split screen display interface. The electronic device displays the split screen display interface, according to the preview of the split screen display interface generated by the user by stitching as shown in FIG. 2E(2). The split screen display interface is divided into a first display area for running and displaying the application A and a second display area for running and displaying the application B. As such, the user can operate the application A and the application B simultaneously on the split screen interface.

In the exemplary embodiment, the split screen display interface may be provided with a multi-function virtual button which is used to cause displaying at least one of a split screen exit control, a swapping control and a group of switching controls.

When the displayed split screen exiting control is triggered, the split screen display interface is controlled to be exited.

When the displayed swapping control is triggered, the first area and the second area in the split screen display interface are controlled to swap applications displayed therein.

The group of switching controls includes a first switching control for switching the first application displayed in the first area of the split screen display interface and a second switching control for switching the at least one second application displayed in the second area in the split screen display interface. The first application displayed in the first area is switched to a third application when the first switching control is triggered, and the at least one second application displayed in the second area is switched to at least one fourth application when the second switching control is triggered.

In some embodiments, when the first switching control is triggered, the multi-task management interface is displayed. On the displayed multi-task management interface, the third application is selected. When the third application is selected, the user is prompted whether to switch the third application to the foreground for displaying. If the user chooses to switch the third application to the foreground for displaying, then the first application displayed in the first display area of the split screen display interface is switched to the third application for displaying. Similarly, when the second switching control is triggered, the multi-task management interface is displayed. On the displayed multi-task management interface, the at least one fourth application is selected. When the fourth application is selected, the user is prompted whether to switch the fourth application to the foreground for displaying. If the user chooses to switch the fourth application to the foreground for displaying, then the second application displayed in the second display area of the split screen display interface is switched to the fourth application for displaying.

In some embodiments, controlling exiting the split screen display interface may comprise: controlling the electronic device to display in a full screen the first application running and displayed in the first area, and controlling the at least one second application running and displayed in the second area to run in the background; or controlling the electronic device to display in a full screen a desktop, and controlling the first application and the at least one second application to run in the background; or controlling the first application running and displayed in the first area to run in the background, and controlling the electronic device to display only the at least one second application run in the second area.

FIG. 2G is a schematic diagram illustrating a split screen display interface according to another exemplary embodiment of the present disclosure. As shown, the split screen display interface is provided with a multi-function virtual button. When the multi-function virtual button is triggered, at least one of a split screen exit control, a swapping control and a group of switching controls is displayed. For example, the switching controls include a first switching control and a second switching control.

FIG. 2H is a schematic diagram illustrating a switched state when the virtual button on the split screen display interface is triggered. When the split screen exit control shown in FIG. 2G is triggered, the electronic device is controlled to display in a full screen the application A running and displayed in the first area, and the application B running and displayed in the second area is controlled to run in the background. The display interface shown in FIG. 2G is switched to the display interface shown in FIG. 2H.

In some embodiments, when the split screen exit control shown in FIG. 2G is triggered, the electronic device is controlled to display in a full screen a desktop and the applications A and B are controlled to run in the background so that the desktop shown in FIG. 2B is displayed. Afterwards, the user may trigger displaying the multi-task management interface again, to select multiple applications to be displayed in a split screen display manner.

In some embodiments, when the user triggers displaying the multi-task management interface shown in FIG. 2C and selects the preview interfaces of the applications A, B and C, the preview interfaces of the applications A, B and C are stitched together to generate a preview image of a split screen display interface as shown in FIG. 2I. After the preview image of the split screen display interface is generated, the user will be prompted whether to display the split screen display interface. If the user confirms displaying the split screen display interface, then the split screen display interface is displayed, as shown in FIG. 2J. The application A is displayed in a first display area, and the applications B and C are displayed in a second display area. The second display area is divided into a first sub-area for displaying the application B and a second sub-area for displaying the application C.

If the user triggers the multi-function virtual button provided on the split screen display interface, at least one of a split screen exit control, a swapping control and a group of switching controls is displayed. For example, if the user selects the split screen exit control, the application A running and displayed in the first area is controlled to run in the background, and the electronic device is controlled to display the applications B and C running in the second area, as shown in FIG. 2K.

According to the split screen method 200, an operation signal which triggers displaying a multi-task management interface is received; the multi-task management interface is displayed; when it is detected that a user selects a first application and at least one second application which are running and displayed on the multi-task management interface, a split screen display interface is generated; and then the first application and the at least one second application are running and displayed on the split screen display interface simultaneously. By running and displaying the first application and the second application selected by the user, on the split screen display interface simultaneously, the user is enabled to use at least two different applications simultaneously, thereby solving the problem in the related prior art that the manner for displaying applications on an electronic device is inconvenient to the user, and accordingly achieving the effect of improving user experience.

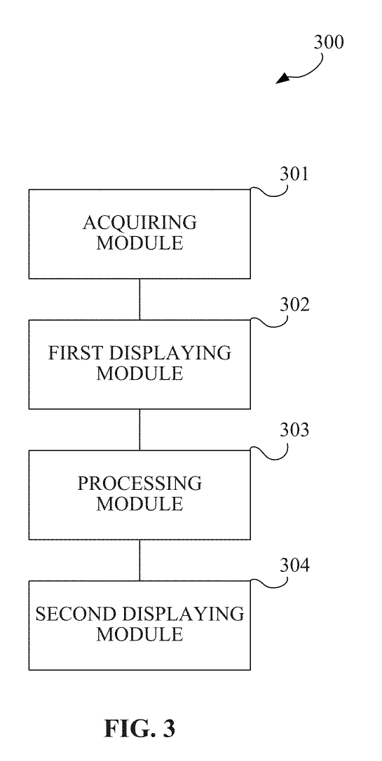

FIG. 3 is a block diagram of a split screen display apparatus 300 according to an exemplary embodiment. The apparatus 300 may be used to implement the above described methods. The apparatus 300 may be implemented in an electronic device having a touch screen and may comprise an acquiring module 301, a first displaying module 302, a processing module 303 and a second displaying module 304.

The acquiring module 301 is configured to receive an operation signal which triggers displaying a multi-task management interface.

The first displaying module 302 is configured to display the multi-task management interface, wherein the multi-task management interface displays thereon acquired applications running on the electronic device.

The processing module 303 is configured to, when it is detected that a user selects a first application and at least one second application which are running, generate a split screen display interface based on the first application and the at least one second application.

The second displaying module 304 is configured to display the split screen display interface, so that the first application and the at least one second application are running and displayed on the split screen display interface simultaneously.

According to the split screen apparatus 300, an operation signal which triggers displaying of a multi-task management interface is received; the multi-task management interface is displayed; when it is detected that a user selects a first application and at least one second application which are running and displayed on the multi-task management interface, a split screen display interface is generated; and then the first application and the at least one second application are running and displayed on the split screen display interface simultaneously. By running and displaying the first application and the second application selected by the user, on the generated split screen display interface simultaneously, the user is enabled to use at least two different applications simultaneously, thereby solving the problem in the related prior art that the manner for displaying applications on an electronic device is inconvenient to the user, and accordingly achieving the effect of improving user experience.

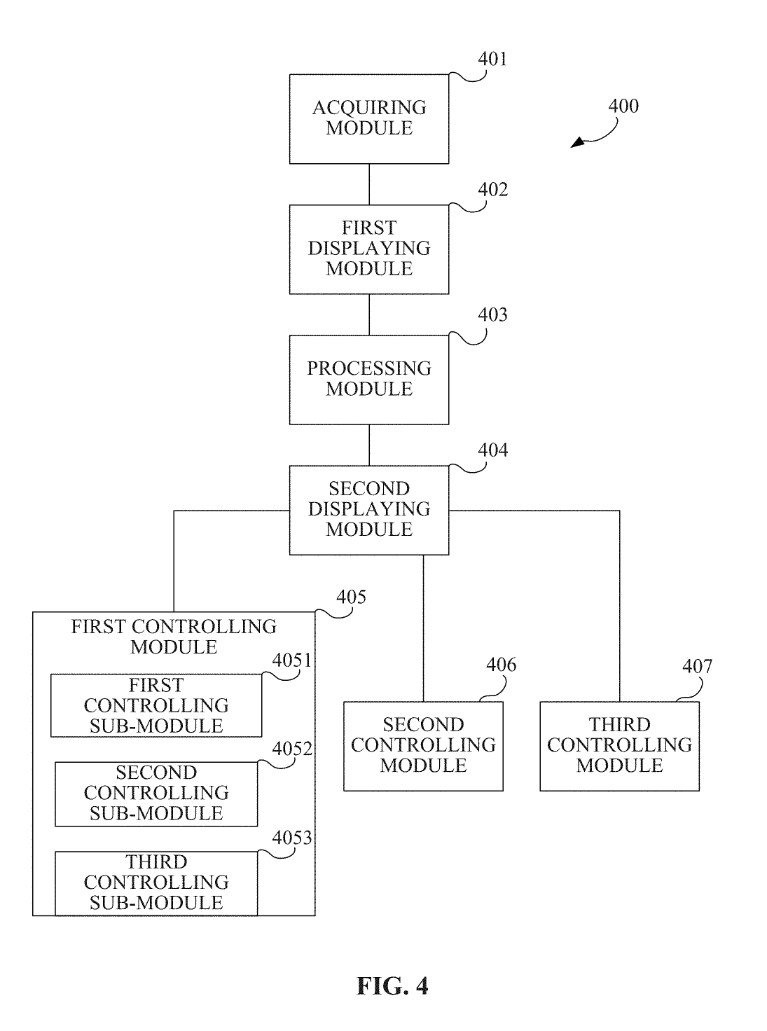

FIG. 4 is a block diagram of a split screen display apparatus 400 according to another exemplary embodiment. The apparatus 400 may be used to implement the above described methods. The split screen display apparatus 400 may be implemented in an electronic device having a touch screen and may comprise an acquiring module 401, a first displaying module 402, a processing module 403 and a second displaying module 404.

The acquiring module 401 is configured to receive an operation signal which triggers displaying a multi-task management interface.

The operation signal may be a signal generated when a physical button on the electronic device is triggered, may be a gesture input by a user on the touch screen of the electronic device, or may be a signal generated when the electronic device is moved along a predetermined trajectory while being shaken. The operation signal is not limited in the present disclosure, and can be determined according to actual conditions.

The multi-task management interface typically displays running applications, and each application may be displayed in the form of its preview interface in the multi-task management interface. The preview interface may be a page most recently displayed on a display screen of the electronic device before the application exits running in the foreground. Alternatively, the preview interface of the application may also be a home interface of the application.

The first displaying module 402 is configured to display the multi-task management interface, wherein the multi-task management interface displays thereon acquired applications running on the electronic device.

The processing module 403 is configured to, when it is detected that a user selects a first application and at least one second application which are running, generate a split screen display interface based on the first application and the at least one second application.

The second displaying module 404 is configured to display the split screen display interface, so that the first application and the at least one second application are running and displayed on the split screen display interface simultaneously.

In this embodiment, the processing module 403 may further be configured to: when it is detected that the user selects the first application and the at least one second application which are running, trigger generation, in the multi-task management interface, of a preview interface corresponding to the split screen display interface based on the first application and the at least one second application.

In the exemplary embodiment, the processing module 403 may further be configured to: sequentially stitch the first application and the at least one second application to generate the preview interface corresponding to the split screen display interface, so that the preview interface is divided into a first display area and a second display area according to the stitching sequence of the first application and the at least one second application, wherein the first display area displays the first application and the second display area displays the at least one second application.

In the exemplary embodiment, the second displaying module 404 may further be configured to: control the electronic device to run and display the split screen display interface according to a page layout of the preview interface, so that the first application is running and displayed in a first area of the split screen display interface and the at least one second application is running and displayed in a second area of the split screen display interface.

In the exemplary embodiment, the split screen display interface may further contain a multi-function virtual button which causes displaying at least one of a split screen exit control, a swapping control and a group of switching controls. The group of switching controls includes a first switching control for switching the first application displayed in the first area of the split screen display interface and a second switching control for switching the at least one second application displayed in the second area of the split screen display interface.

The apparatus 400 may further comprise: a first controlling module 405, a second controlling module 406 and a third controlling module 407.

The first controlling module 405 is configured to, when the displayed split screen exit control is triggered, control exiting the split screen display interface. The second controlling module 406 is configured to, when the displayed swapping control is triggered, control the first area and the second area in the split screen display interface to swap applications displayed therein. The third controlling module 407 is configured to switch the first application displayed in the first area to a third application when the first switching control is triggered, and to switch the at least one second application displayed in the second area to at least one fourth application when the second switching control is triggered.

In the exemplary embodiment, the first controlling module 405 may comprise at least one of a first controlling sub-module 4051, a second controlling sub-module 4052 or a third controlling sub-module 4053.

The first controlling sub-module 4051 is configured to control the electronic device to display in a full screen the first application running and displayed in the first area, and to control the at least one second application running and displayed in the second area to run in the background.

The second controlling sub-module 4052 is configured to control the electronic device to display in a full screen a desktop, and to control the first application and the at least one second application to run in the background.

The third controlling sub-module 4053 is configured to control the first application running and displayed in the first area to run in the background, and to control the electronic device to display only the at least one second application run in the second area.

According to the split screen apparatus 400, an operation signal which triggers displaying a multi-task management interface is received; the multi-task management interface is displayed; when it is detected that a user selects a first application and at least one second application which are running and displayed on the multi-task management interface, a split screen display interface is generated; and then the first application and the at least one second application are running and displayed on the split screen display interface simultaneously. By running and displaying the first application and the second application selected by the user, on the generated split screen display interface simultaneously, the user is enabled to use at least two different applications simultaneously, thereby solving the problem in the related prior art that the manner for displaying applications on an electronic device is inconvenient to the user, and accordingly achieving the effect of improving user experience.

An exemplary embodiment of the disclosure provides a split screen display apparatus which can perform the above described split screen display methods. The split screen display apparatus may comprise a processor, and a memory storing instructions executable by the processor. The processor is configured to: receive an operation signal which triggers displaying a multi-task management interface; display the multi-task management interface, wherein the multi-task management interface displays thereon acquired applications running on the electronic device; and when it is detected that a user selects a first application and at least one second application which are running, generate a split screen display interface based on the first application and the at least one second application; and display the split screen display interface, so that the first application and the at least one second application are running and displayed on the split screen display interface simultaneously.

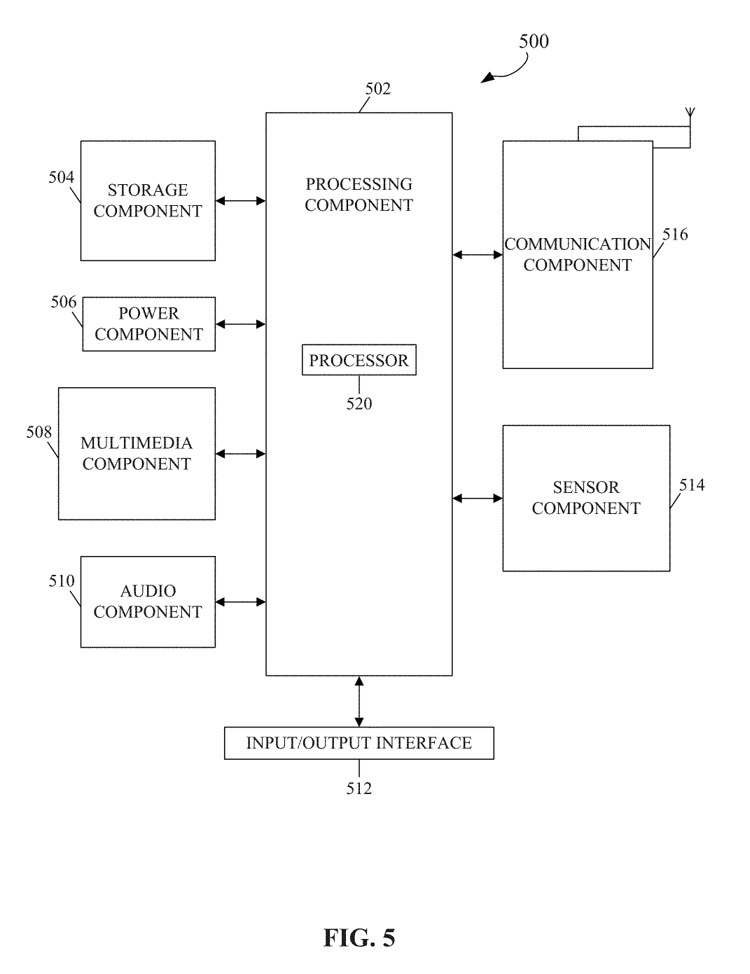

FIG. 5 is a block diagram of a split screen display apparatus 500 according to an exemplary embodiment. For example, the apparatus 500 may be a mobile phone, a computer, a digital broadcast terminal, a messaging device, a gaming console, a tablet device, a medical device, exercise equipment, a personal digital assistant or the like.

Referring to FIG. 5, the apparatus 500 may comprise one or more of the following components: a processing component 502, a storage component 504, a power component 506, a multimedia component 508, an audio component 510, an input/output (I/O) interface 512, a sensor component 514 and a communication component 516.

The processing component 502 typically controls overall operations of the apparatus 500, such as the operations associated with display, telephone calls, data communications, camera operations and recording operations. The processing component 502 may include one or more processors 520 to execute instructions to perform all or some of the steps in the above described methods. Moreover, the processing component 502 may include one or more modules which facilitate the interaction between the processing component 502 and other components. For example, the processing component 502 may comprise a multimedia module to facilitate the interaction between the multimedia component 508 and the processing component 502.

The storage component 504 is configured to store various types of data to support the operation of the apparatus 500. Examples of such data comprise instructions for any applications or methods operated on the apparatus 500, various kinds of data, messages, pictures, video, etc. The storage component 504 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the apparatus 500. The power component 506 may comprise a power management system, one or more power sources, and any other components associated with the generation, management, and distribution of power in the apparatus 500.

The multimedia component 508 comprises a screen providing an output interface between the apparatus 500 and the user. In some embodiments, the screen may comprise a liquid crystal display (LCD) and a touch panel. If the screen comprises the touch panel, the screen may be implemented as a touch screen to receive input signals from the user. The touch panel comprises one or more touch sensors to sense touches, swipes and gestures on the touch panel. The touch sensors may not only sense a boundary of a touch or swipe action, but also sense a period of time and a pressure associated with the touch or swipe action. In some embodiments, the multimedia component 508 includes a front camera and/or a rear camera. The front camera and the rear camera may receive an external multimedia datum while the apparatus 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 includes a microphone configured to receive an external audio signal when the apparatus 500 is in an operation mode, such as a call mode, a recording mode, and a voice recognition mode. The received audio signal may be further stored in the storage component 504 or transmitted via the communication component 516. In some embodiments, the audio component 510 further includes a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 comprises one or more sensors to provide status assessments of various aspects of the apparatus 500. For instance, the sensor component 514 may detect an open/closed status of the apparatus 500, relative positioning of components, e.g., the display and the keypad, of the apparatus 500, a change in position of the apparatus 500 or a component of the apparatus 500, presence or absence of user's contact with the apparatus 500, an orientation or an acceleration/deceleration of the apparatus 500, and a change in temperature of the apparatus 500. The sensor component 514 may include a proximity sensor configured to detect the presence of nearby objects without any physical contact. The sensor component 514 may also include a light sensor, such as a CMOS or CCD image sensor, for use in imaging applications. In some embodiments, the sensor component 514 may also include an accelerometer sensor, a gyroscope sensor, a magnetic sensor, a pressure sensor or a temperature sensor.

The communication component 516 is configured to facilitate communication, wired or wirelessly, between the apparatus 500 and other devices. The apparatus 500 can access a wireless network based on a communication standard, such as WiFi, 2G, 3G, or 4G, or a combination thereof. In one embodiment, the communication component 516 receives a broadcast signal or broadcast associated information from an external broadcast management system via a broadcast channel In one embodiment, the communication component 516 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment, the apparatus 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above methods.

In an embodiment, there is also provided a non-transitory computer-readable storage medium having instructions stored thereon, such as the storage component 504 having instructions executable by the processor 520 in the apparatus 500, for performing the above-described split screen display methods. For example, the non-transitory computer-readable storage medium may be a ROM, a RAM, a CD-ROM, a magnetic tape, a floppy disc, an optical data storage device or the like.

The non-transitory computer-readable storage medium has stored therein instructions that, when executed by the processor 520 of the apparatus 500, may cause the apparatus 500 to perform the above described methods.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of sub-modules.

Other embodiments of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only, with a true scope and spirit of the disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

What is claimed is:

1. A method for split screen display on an electronic device, comprising:
receiving an operation signal which triggers displaying a multi-task management interface;
displaying the multi-task management interface, wherein the multi-task management interface displays thereon acquired applications running on the electronic device;
when it is detected that a user selects a first application and at least one second application from the acquired applications, generating a split screen display interface based on the first application and the at least one second application; and
displaying the split screen display interface, so that the first application and the at least one second application are running and displayed on the split screen display interface simultaneously.

2. The method of claim 1, wherein the generating the split screen display interface based on the first application and the at least one second application comprises:
triggering generation, in the multi-task management interface, of a preview interface corresponding to the split screen display interface based on the first application and the at least one second application.

3. The method of claim 2, wherein the triggering generation, in the multi-task management interface, of the preview interface corresponding to the split screen display interface based on the first application and the at least one second application comprises:
sequentially stitching the first application and the at least one second application to generate the preview interface, so that the preview interface is divided into a first display area and a second display area according to a stitching sequence of the first application and the at least one second application, wherein the first display area displays the first application and the second display area displays the at least one second application.

4. The method of claim 3, wherein the displaying the split screen display interface, so that the first application and the at least one second application are running and displayed on the split screen display interface simultaneously, comprises:
controlling the electronic device to run and display the split screen display interface according to a page layout of the preview interface, so that the first application is running and displayed in a first area of the split screen display interface and the at least one second application is running and displayed in a second area of the split screen display interface.

5. The method of claim 1, wherein the split screen display interface contains a multi-function virtual button which causes displaying a split screen exit control, the method further comprising:
when the displayed split screen exit control is triggered, controlling exiting the split screen display interface.

6. The method of claim 1, wherein the split screen display interface contains a multi-function virtual button which causes displaying a swapping control, the method further comprising:
when the displayed swapping control is triggered, controlling the first area and the second area in the split screen display interface to swap applications displayed therein.

7. The method of claim 1, wherein the split screen display interface contains a multi-function virtual button which causes displaying a group of switching controls, the group of switching controls including a first switching control for switching the first application displayed in a first area in the split screen display interface and a second switching control for switching the at least one second application displayed in a second area in the split screen display interface, the method further comprising:
switching the first application displayed in the first area to a third application when the first switching control is triggered; and
switching the at least one second application displayed in the second area to at least one fourth application when the second switching control is triggered.

8. The method of claim 1, wherein the split screen display interface contains a multi-function virtual button which causes displaying at least one of a split screen exit control, a swapping control and a group of switching controls, the group of switching controls including a first switching control for switching the first application displayed in the first area in the split screen display interface and a second switching control for switching the at least one second application displayed in the second area in the split screen display interface, the method further comprising:
when the displayed split screen exit control is triggered, controlling exiting the split screen display interface;
when the displayed swapping control is triggered, controlling the first area and the second area in the split screen display interface to swap applications displayed therein;
switching the first application displayed in the first area to a third application when the first switching control is triggered; and
switching the at least one second application displayed in the second area to at least one fourth application when the second switching control is triggered.

9. The method of claim 5, wherein the controlling exiting the split screen display interface comprises at least one of:
controlling the electronic device to display in a full screen the first application, and controlling the at least one second application to run in a background;
controlling the electronic device to display in a full screen a desktop, and controlling the first application and the at least one second application to run in a background; or
controlling the first application to run in a background, and controlling the electronic device to display only the at least one second application run in the second area.

10. An apparatus for split screen display, comprising:
a processor, and
a memory storing instructions executable by the processor,
wherein the processor is configured to:
receive an operation signal which triggers displaying a multi-task management interface;
display the multi-task management interface, wherein the multi-task management interface displays thereon acquired applications running on the apparatus;
when it is detected that a user selects a first application and at least one second application from the acquired applications, generate a split screen display interface based on the first application and the at least one second application; and
display the split screen display interface, so that the first application and the at least one second application are running and displayed on the split screen display interface simultaneously.

11. The apparatus of claim 10, wherein the processor is further configured to:
trigger generation, in the multi-task management interface, of a preview interface corresponding to the split screen display interface based on the first application and the at least one second application.

12. The apparatus of claim 11, wherein the processor is further configured to:
sequentially stitch the first application and the at least one second application to generate the preview interface corresponding to the split screen display interface, so that the preview interface is divided into a first display area and a second display area according to a stitching sequence of the first application and the at least one second application, wherein the first display area displays the first application and the second display area displays the at least one second application.

13. The apparatus of claim 12, wherein the processor is further configured to:
control the apparatus to run and display the split screen display interface according to a page layout of the preview interface, so that the first application is running and displayed in a first area of the split screen display interface and the at least one second application is running and displayed in a second area of the split screen display interface.

14. The apparatus of claim 10, wherein the split screen display interface contains a multi-function virtual button which causes displaying a split screen exit control, the processor being further configured to:
when the displayed split screen exit control is triggered, control exiting the split screen display interface.

15. The apparatus of claim 10, wherein the split screen display interface contains a multi-function virtual button which causes displaying a swapping control, the processor being further configured to:
when the displayed swapping control is triggered, control the first area and the second area in the split screen display interface to swap applications displayed therein.

16. The apparatus of claim 10, wherein the split screen display interface contains a multi-function virtual button which causes displaying a group of switching controls, the group of switching controls including a first switching control for switching the first application displayed in a first area in the split screen display interface and a second switching control for switching the at least one second application displayed in a second area in the split screen display interface, the processor being further configured to:
switch the first application displayed in the first area to a third application when the first switching control is triggered; and
switch the at least one second application displayed in the second area to at least one fourth application when the second switching control is triggered.

17. The apparatus of claim 13, wherein the split screen display interface contains a multi-function virtual button which causes displaying at least one of a split screen exit control, a swapping control and a group of switching controls, the group of switching controls including a first switching control for switching the first application displayed in the first area in the split screen display interface and a second switching control for switching the at least one second application displayed in the second area in the split screen display interface, the processor being further configured to:
when the displayed split screen exit control is triggered, control exiting the split screen display interface;
when the displayed swapping control is triggered, control the first area and the second area in the split screen display interface to swap applications displayed therein;
switch the first application displayed in the first area to a third application when the first switching control is triggered: and
switch the at least one second application displayed in the second area to at least one fourth application when the second switching control is triggered.

18. The apparatus of claim 14, wherein the processor is further configured to perform at least one of:
controlling the electronic device to display in a full screen the first application, and controlling the at least one second application to run in the background;
controlling the electronic device to display in a full screen a desktop, and controlling the first application and the at least one second application to run in the background; or
controlling the first application to run in the background, and controlling the electronic device to display only the at least one second application run in the second area.

19. A non-transitory computer-readable storage medium having stored therein instructions that, when executed by a processor of an apparatus, causes the apparatus to perform a split screen display method, the method comprising:
receiving an operation signal which triggers displaying a multi-task management interface;
displaying the multi-task management interface, wherein the multi-task management interface displays thereon acquired applications running on the apparatus;
when it is detected that a user selects a first application and at least one second application from the acquired applications, generating a split screen display interface based on the first application and the at least one second application; and
displaying the split screen display interface, so that the first application and the at least one second application are running and displayed on the split screen display interface simultaneously.

20. The non-transitory computer-readable storage medium of claim 19, wherein the generating the split screen display interface based on the first application and the at least one second application comprises:
triggering generation, in the multi-task management interface, of a preview interface corresponding to the split screen display interface based on the first application and the at least one second application.
